(19) United States
(12) Patent Application Publication
(10) Pub. No.: US 2002/0087359 A1
(43) Pub. Date: Jul. 4, 2002

(54) Medical system architecture with computer workstations having a device for work list management

(76) Inventor: Siegfried Bocionek, Nurnberg (DE)

Correspondence Address: SCHIFF HARDIN & WAITE, 6600 SEARS TOWER, 233 S WACKER DR, CHICAGO, IL, 60606-6473, US

(21) Appl. No.: 09/994,122

(22) Filed: Nov. 26, 2001

(30) Foreign Application Priority Data
Nov. 24, 2000 (DE) 10058567.1
Nov. 5, 2001 (DE) 10153832.4

(51) Int. Cl. G06F 17/60

(52) U.S. Cl. 705/2

(57) ABSTRACT

In a medical system architecture and method with at least one modality acquires examination images, computer workstations allocated to the respective modalities process the examination images, data and the examination images, and able to be transmitted a device for storing the data and examination images and to further computer workstations for post-processing the data and examination images. Each of the computer workstations for processing and post-processing the examination images has a device for work list management and a detector that determines the usage of the computer workstation on the basis of the work list and which communicates a signal corresponding to the degree of usage to at least one task generator. The task generator has an evaluation device that reacts according to the received signals from the computer workstations.

### BACKGROUND OF THE INVENTION

1. Field of the Invention

The present invention is directed to a medical system architecture of the type having at least one modality for acquiring examination images, computer workstations allocated to the respective modalities for processing the examination images, a device for transmitting data and the examination images, a device for storing the data and examination images, and further computer workstations for post-processing the data and examination images, and also is directed to a method for the usage of a computer workstation.

2. Description of the Prior Art

The book “Bildgebende Systeme für die medizinische Diagnostik”, edited by H. Morneburg, 3^{rd} Edition, 1995, pages 684 ff., discloses medical system architectures, referred to as PACS (Picture Archival and Communication Systems) wherein image viewing and image processing locations, what are referred to as work stations, are connected to one another via an image communication network for fetching patient data and images generated by modalities.

Many computer workstations, especially in the clinical field, organize routine jobs in the form of work lists such as, for example, the work list of the images on a PACS diagnosis or viewing workstation to be diagnosed by a radiologist, the work list of the laboratory data of a patient to be analyzed on a personal computer with LIS (laboratory information system) application or on operator consoles of the imaging modalities. Usually, the new work list entries are generated when the information to be processed is sent via a computer network or a communication network from the location at which the information arises, for example a radiological modality or a laboratory analyzer, to the computer workstation for the analysis.

In general, the information to be processed can be sent to arbitrary computer workstations on which the same software application is installed for the processing. Which of the possible computer workstations is selected has usually been statically defined when setting up the workflow; for example, all CT images of the skull go to a first computer and all MR images go to a second computer. When more CT images than MR images arise, then the first computer is overburdened whereas the second computer is under utilized. A dynamic distribution dependent on further parameters that are known at the location at which the information arise is also possible.

The problem has not been previously solved in the context of clinical workstation systems. The standards that exist between medical devices and computer applications, for example DICOM, HL-7, CorbaMed, contain no protocols and message formats in order to exchange standardized information about work list scope and workload for the computer workstation. DICOM (Digital Imaging and Communications in Medicine) is an industrial standard for the transmission of images and other medical information between computers for enabling digital communication between diagnosis and therapy devices of different manufacturers. HL7 (Health Level 7) is an ANSI-approved standard of the Standards Developing Organizations (SDOs). HL7 specification is the application protocol for electronic data exchange in the medical environment.

One possibility would be to centrally control usage of the computer workstations with a task manager (i.e. a task manager program, similar to that in an operating system) or with a type of “production planning system” for clinical computer workstations (production planning systems are usually utilized in manufacturing and, among other things, plan the optimized usage of the various machines in the factory). Both approaches are based on a centralized control approach and can only be realized in practical terms in a very expensive way and with great outlay.

### SUMMARY OF THE INVENTION

An object of the invention is to provide a medical system architecture and method of the type initially described wherein a dynamic distribution of the information to be processed to the computer workstations ensues on the basis of usage data for these workstations without requiring a centralized approach.

This object is inventively achieved in an architecture wherein the computer workstations for processing and post-processing the examination images have a device for work list management and a detector that determines the usage of the computer workstation on the basis of the work list, and which communicates a signal corresponding to the degree of usage to at least one task generator (modality, laboratory devices, etc.). The (at least one) task generator has an evaluation device that reacts according to the received signal of the computer workstation and sends further information for processing on demand. A decentralized, uniformly distributed, need-controlled usage strategy of computer workstations that receive and manage orders in the form of work list entries is achieved by this auto-fetch function.

The usage can be controlled in a simple way when the detector includes threshold comparator that compares the number of still pending or unprocessed diagnostic cases in the work list to input values and generates a request signal and sends it to the task generators when the workload of the computer workstation with diagnostic cases to be processed falls below a request threshold. Alternatively or additionally, the threshold comparator can generate a saturation signal and send it to the task generators when the workload of the computer workstation with diagnostic cases to be processed exceeds a saturation threshold.

It has proven advantageous when the components that generate or manage diagnostic information include a task generator that forwards the diagnostic cases to be processed in conformity with the signals. Such components that generate or manage diagnostic information can, for example, be the imaging modalities, RIS, laboratory devices or LIS. Alternatively or additionally, the task generator can have a connection to a server with a routing device that forwards the incoming diagnostic cases to be processed in conformity with the signals.

The above object also is achieved in a method for usage of a computer workstation in accordance with the invention having the following steps:

a) The workload of diagnostic cases to be processed is determined on the basis of a work list.

b) When the workload of the computer workstation with diagnostic cases to be processed falls below a request threshold, a request signal is communicated to at least one task generator.

c) When the workload of the computer workstation exceeds a saturation threshold, a saturation signal is communicated to at least one task generator.

d) When a task generator receives a request signal, further diagnostic cases to be processed are sent to the computer workstation.

e) When a task generator receives a saturation signal, no diagnostic case to be processed is sent to the computer workstation.

### DESCRIPTION OF THE DRAWINGS

FIG. 1 is a block diagram of an example of a system architecture of a hospital; and

FIG. 2 is a schematic illustration of a computer workstation according to FIG. 1 with an inventive detector.

### DESCRIPTION OF THE PREFERRED EMBODIMENTS

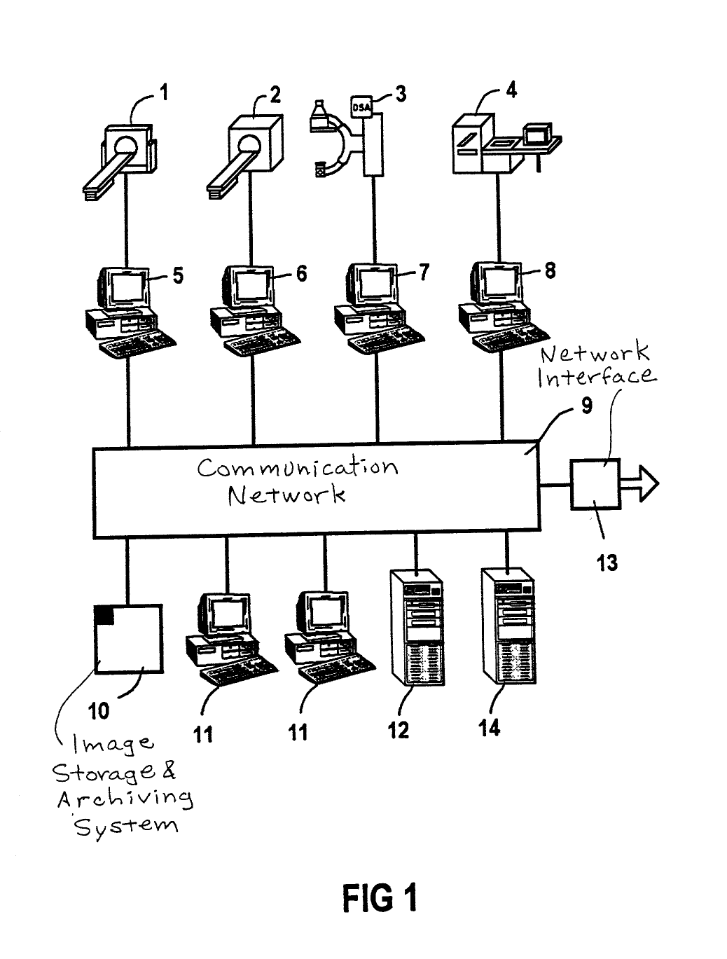

FIG. 1 shows the system architecture of a hospital network as an example. The modalities 1 through 4 serve for the acquisition of medical images; these can, for example, be a CT unit 1 for computed tomography, an MR unit 2 for magnetic resonance imaging, a DSA unit 3 for digital subtraction angiography and an X-ray unit 4 for digital radiography 4 as image-generating systems. Operator consoles 5 through 8 of the modalities or workstations are connected to these modalities, the acquired medical images being capable of being processed and locally stored therewith. Patient data belonging to the images can also be input.

The operator consoles 5 through 8 are connected to a communication network 9 as a LAN/WAN backbone for distributing the generated images and for communication. Thus, for example, the images generated in the modalities 1 through 4 and the images that are further-processed in the operator consoles through 8 can be stored in a central image storage and image archiving system 10 or can be forwarded to other workstations.

Further viewing workstations, represented by a workstation 11, are connected to the communication network 9 as diagnostics consoles that have local image memories. For example, such a viewing workstation 11 is a very fast mini-computer employing one or more fast processors. The images that are acquired and entered in the image archiving system 10 can be subsequently called in the viewing workstations 11 for diagnosis and can be stored in the local image memory, from which they can be immediately available to the diagnostician working at the viewing workstation 11.

Further, servers 12, for example patient data servers (PDS), file servers, program servers and/or EPR (electronic patient record) servers, are connected to the communication network 9.

The image and data exchange via the communication network 9 ensues according to the DICOM standard, an industry standard for the transmission of images and further medical information between computers, so that a digital communication between diagnosis and therapy devices of different manufacturers is possible. A network interface 13 via which the internal communication network 9 is connected to a global data network, for example the world wide web, can be connected to the communication network 9, so that the standardized data can be exchanged with different networks world-wide.

An RIS server 14 with which the operator consoles 5 through 8 communicate via TCP/IP protocols by means of the communication network 9 is connected to the communication network 9.

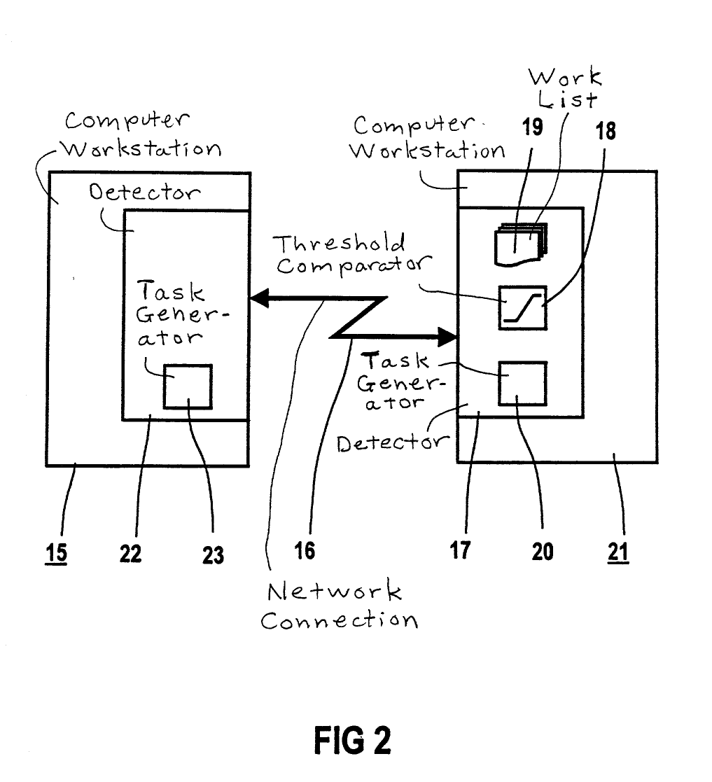

FIG. 2 shows two computer workstations 15 and 21, the first thereof may be an operator console 5 through 8 and the second may be a viewing workstation 11. They are in contact with one another via a network connection 16. The computer workstation 21 of the viewing workstation 11 is provided with a detector 17 that has a threshold comparator 18 that has access to a work list of the computer workstation 21. The detector 17 of the computer workstation 21 is also provided with a task generator 20 that receives the output signals of the other computer workstations 15.

Each of the computer workstation 15 of the operator consoles 5 through 8 has a detector 22 with a task generator 23 that receives the output signals of the threshold comparator 18 of the other computer workstation 21.

The usage degree of the computer workstation 21 in terms of diagnostic cases to be processed is determined on the basis of the work list 19, whereby the threshold comparator 18 compares the current status of the workload to one or two reference or threshold values. When the workload of the computer workstation 21 falls below a request threshold, then the threshold comparator 18 generates a request signal and communicates it to the task generator 23. When the workload of the computer workstation 21 exceeds a saturation threshold, a saturation signal is communicated to the task generator 23.

When the task generator 23 receives a request signal, further diagnostic cases to be processed are sent from this computer workstation 15 to the computer workstation 21 that has sent the request signal. When a task generator 23 receives a saturation signal, a diagnostic case to be processed is no longer sent to the computer workstation 21 that has sent the saturation signal.

A routing device that coordinates the dispatching can be provided instead of using the task generator 23 to send diagnostic cases to be processed. For example, this routing device can be implemented in the RIS server 14.

The invention is thus based on a distributed solution that is fast to implement. As a result of the inventive, dynamic distribution of the information to be processed to the computer workstations on the basis of workload data for these workstations, new cases can be sent in prioritized fashion to computer-2 when, for example, there are still 50 cases to be processed present at computer-1 but only 10 at computer-2.

Clinical information systems often contain a feature referred to as workflow functionality that is employed for the automated transport of information via computer networks. For example, an RIS (radiology information system) can trigger what is referred to as a “pre-fetch” function that automatically searches earlier findings about a patient from a digital medical image archive and automatically forwards them to the diagnosis computer workstation at which the radiologist also wishes to diagnose the newly produced images of the patient. The pre-fetch feature allows the time for producing new images—the examination time of the patient—to be used for the automated actions, and both old and new images are already dependably present on the computer workstation at which the radiologist wishes to diagnose the case. The auto-routing of clinical information to a task generator that is already known at the dispatch time functions similarly.

The present invention is directed to another automatic workflow functionality that, using a digital message or some other digital signal via the computer network, “informs” the components that generate or manage the diagnostic information, for example the modalities, RIS, laboratory devices, LIS, etc., in a hospital, that there is still or is again free capacity for the processing of diagnostic data or images. In response to this message, the components that have been “notified” send the next diagnostic cases to the requesting computer workstations. This workflow functionality of requesting diagnostic data when the workload of the computer work station with diagnostic cases to be processed calls below a certain threshold can be called “AutoFetch”.

The “AutoFetch” functionality can be realized by integrating functions or components, that monitor the plurality of as yet unprocessed cases in the work list, into the applications on every computer workstation with applications that include a work list management. Additionally, two configurable threshold parameters—the request threshold and the saturation threshold—that can be set to a fixed value must be embedded into the application. The “AutoFetch” functionality then continuously compares the values of these threshold parameters to the number of unprocessed cases in the work list. When the number of unprocessed cases falls below the request threshold, then the “AutoFetch” functionality sends a digital message to the components that generate or manage the diagnostic information such as, for example, modalities, RIS, laboratory devices, LIS, etc., and requests further cases. When the number of unprocessed cases rises above the saturation threshold, then the “AutoFetch” functionality no longer requests any new cases. An Alternative solution is for the “AutoFetch” functionality to send a separate message to the components that generate or manage the diagnostic information indicating they should send no further cases.

In addition to the implementation of the “AutoFetch” functionality on the computer workstations, reception and evaluation means for the messages of the “AutoFetch” functionality are provided on the components that generate or manage diagnostic information.

The inventive solution is decentrally organized since no single, central computer process need be put in place that monitors which computer workstations still have free capacity for processing. The implementation can be realized by digital message exchange between computer programs. Overall, the outlay for implementing “AutoFetch” can be kept significantly lower than if the alternatives of central task manager or production planning system were realized instead.

Although modifications and changes may be suggested by those skilled in the art, it is the intention of the inventor to embody within the patent warranted hereon all changes and modifications as reasonably and properly come within the scope of his contribution to the art.

I claim as my invention:

1. A medical system architecture comprising:
a plurality of modalities for acquiring examination images;
a plurality of computer workstations respectively allocated to the modalities for processing the respective examination images therefrom;
a transmission device connected to said computer workstations for transmitting said examination images to a location remote from said computer workstations;
a memory connected to said transmission device for storing said examination images;
a further computer workstation connected to said transmission device for post-processing said examination images;
each of said computer workstations and said further computer workstation containing a work list management unit in which a work list is stored and which has a detector that determines usage of that computer workstation dependent on the stored work list; and
a task generator in communication via said transmission device with the respective work list management units of the computer workstations and the further computer workstation, said task generator including an evaluation device which reacts to the respective received signals from said computer workstations and said further computer workstation to manage usage of the computer workstations and the further computer workstation.

2. A medical system architecture as claimed in claim 1 wherein said detector comprises a threshold detector that compares a number of still pending cases in said work list to an input value, and which generates a request signal and transmits it to said task generator when a work load at that computer workstation falls below a request threshold represented by said input value.

3. A medical system architecture as claimed in claim 1 wherein each detector comprises a threshold comparator that compares a number of still pending diagnostic cases in said work list to an input value and which generates a saturation signal and transmits said saturation signal to said task generator when a work load at that computer workstation with diagnostic cases to be processed exceeds a saturation threshold represented by said input value.

4. A medical system architecture as claimed in claim 1 wherein each of said computer workstation contains a task generator.

5. A medical system architecture as claimed in claim 1 further comprising a server with a routing device connected to said task generator, said server forwarding said diagnostic cases to respective workstations among said computer workstations and said further computer workstation dependent on the respective signals received by said task generator.

6. A method for controlling usage of a computer workstation, comprising the steps of:
processing a work load of diagnostic cases at a computer workstation dependent on a work list;
if a work load of said diagnostic cases at said computer workstation falls below a request threshold, communicating a request signal to a task generator located remote from said computer workstation;
if said work load of said computer workstation exceeds a saturation threshold, communicating a saturation signal to said task generator;
when said task generator receives said request signal, transmitting further diagnostic cases to be processed to said computer workstation; and
when said task generator receives said saturation signal, inhibiting transmission of further diagnostic cases to be processed to said computer workstation.
